(19) United States
(12) Patent Application Publication
(10) Pub. No.: US 2019/0381467 A1
(43) Pub. Date: Dec. 19, 2019

(54) PRODUCTION PLANT AND METHOD

(71) Applicant: BÜHLER AG, Uzwil (CH)

(72) Inventors: Achim Philipp STURM, Niederuzwil (CH); Eduard NATER, Zuckenriet (CH)

(21) Appl. No.: 16/471,662

(22) PCT Filed: Dec. 21, 2017
(86) PCT No.: PCT/EP2017/084053

§ 371 Date: Jun. 20, 2019

(30) Foreign Application Priority Data
Dec. 23, 2016 (EP) 16206567.6

(51) Int. Cl. B01F 7/14; B01F 3/12; B01F 7/00; B01F 7/30; B01F 13/10; B01F 15/06; B01F 15/02; B01F 5/10

(52) U.S. Cl. CPC B01F 7/145; B01F 3/1221; B01F 7/00808; B01F 7/00525; B01F 7/305; B01F 15/00207; B01F 15/068; B01F 15/0237; B01F 5/104; B01F 2015/061; B01F 13/1027

(57) ABSTRACT

A production plant for processing a suspension and a method for dispersing suspensions. The production plant comprises an extractor or a planetary roller mixer (1), a conveying device and a metering device. The planetary roller mixer (1) comprises at least one central spindle (2) with a toothing (3), at least one planetary spindle (4) with a toothing (5) and a housing (6) with an inner toothing (7) or a housing comprising at least one bushing (8) with an inner toothing (7). The planetary roller mixer (1) further comprises at least one product inlet (9) and at least one product outlet (10). During normal operation, the product outlet (10) is above the product inlet (9) and/or comprises an overflow (14) in the product discharge line (13) provided at the product outlet (10) so that the processing zone of the planetary roller mixer (1) can be substantially completely filled with the suspension.

The invention concerns a production plant for processing a suspension and a method for dispersing suspensions.

Suspensions, i.e. liquids with finely distributed solid particles, such as printing inks, battery slurries, adhesives and sealants, lubricants and cosmetics, have so far mainly been processed in rolling mills and agitator mills, whereby a fine and uniform distribution of the solid particles in the liquid is to be achieved. In addition to homogenization, comminution of the solid particles can be achieved or at least the presence of clumping can be prevented. The rollers and mills can be run through several times if the desired quality requires it.

Rolling mills with open-rotating rolls and/or open roll nip pose a safety problem as there may be a risk to personnel. Closed systems should be preferred, taking safety aspects into account. However, rolling mills are difficult to close due to product management. If several roll passes are necessary, a lot of manual work can be required due to the usually high product viscosity of suspensions. This includes removing the dispersed product from the discharge plate, emptying the rolling mill and changing the product containers. Automation is only possible to a limited extent.

Agitator ball mills are closed systems, but require a higher effort. For example, the grinding media must be separated and care must be taken to avoid clogging of separation devices or discharge openings by grinding media and/or oversized product. When changing products, it may also be necessary to remove the grinding media from the process chamber in order to completely clean the machine. This means a longer downtime.

Planetary roller extruders are also known from the state of the art. These are mainly used for the production of plastics, whereby several solid or liquid product components can be added to the extruder, compressed, mixed, plasticized, dispersed and chemically converted. The processed mass is continuously pressed under pressure through a nozzle or outlet opening. For this purpose, a pressure of up to about 100 bar can be produced in the extruder. The highest pressure is present in the process zone towards the product outlet or at the product outlet itself. The central spindle is therefore usually connected to a drive on the side of the product inlet.

As a rule, it must be prevented that the finished mass flows back into the filling area. The material can be fed from dosing units arranged above the extruder into a filling cylinder of the extruder. As a rule, the planetary roller extruder is equipped with a single-screw filling part, which is either arranged in the housing of the planetary roller extruder or directly upstream of the product inlet. The planetary roller extruder can be arranged vertically, with the mass passing through the extruder from top to bottom. In the vertical arrangement, the material naturally flows in the direction of gravity, and thus away from an upper filling area.

Planetary roller extruders are typically made of steel.

The task of the invention is to avoid the disadvantages of the known and to provide a device, a production plant and a method with which high-quality dispersions can be made available in a way that is acceptable in terms of safety.

The task is solved by a production plant for dispersing a suspension with a planetary roller mixer.

The planetary roller mixer comprises a housing which is essentially cylindrical on the inside, i.e. whose interior has a rotational symmetry with respect to a longitudinal axis, and which is provided with an internal toothing. Alternatively or additionally, the housing may have at least one essentially cylindrical bushing with internal teeth. The planetary roller mixer comprises at least one product inlet in a first end portion of the housing and at least one product outlet in a second end portion of the housing.

The planetary roller mixer comprises at least one central spindle with toothing arranged in the housing and at least one planetary spindle with toothing arranged in the housing, whereby the toothing of the planetary spindle is in operative connection with both the toothing of the central spindle and the internal toothing of the housing or the bushing.

Several planet spindles are preferably arranged around a central spindle.

The planetary roller mixer preferably has a central spindle. Alternatively, for example, several central spindles can be arranged one behind the other in the longitudinal direction on one axis.

The internal gearing may be mounted directly on the housing or it may be mounted on a bushing which may be interchangeably located within the housing.

The housing and, if applicable, the socket are fixed.

During operation, the central spindle is usually rotated about a longitudinal axis by a driving device arranged outside the housing.

The gear teeth of the planetary spindles are on the one hand operatively connected with the gear teeth of the central spindle and on the other hand with the internal gear teeth. The planet spindles are also rotated by the drive of the central spindle.

The housing or bushing, the central spindle and the planetary spindles enclose the process zone of the planetary roller mixer.

The process zone in which the suspension can be located and in which it is processed is located between the planetary spindles and the internal teeth of the housing or bushing, between the central spindle and the internal teeth of the housing or bushing, and between the planetary spindles and the central spindle. The length of the toothed spindles is preferably greater than or equal to their largest diameter, in particular greater than or equal to the largest diameter of the inner spindle. The planetary roller mixer comprises at least one product inlet via which suspension can be introduced into the process zone of the planetary roller mixer and at least one product outlet via which suspension can be discharged from the process zone of the planetary roller mixer. Product inlet and outlet are typically formed by openings in the housing. Preferably, product inlet and product outlet allow a fluid connection, especially a direct one, into and out of the process zone.

In particular, the planetary roller mixer does not have a separate solids inlet.

In particular, the planetary roller mixer does not include a screw conveyor integrated into the housing or directly connected to the process zone.

The product outlet is located above or at the same level as the product inlet during intended use.

In the intended operating arrangement, the product outlet and the product inlet are preferably designed in such a way that the process zone of the planetary roller mixer can essentially be completely filled with suspension.

Essentially completely fillable means that the process zone can be filled to at least 80%, preferably to at least 90%, particularly preferably to at least 95% and the planetary roller mixer can be operated with a process zone which is filled to at least 80%, preferably to at least 90%, particularly preferably to at least 95%, with suspension.

In the filled planetary roller mixer, gas quantities may be present which, for example, have been introduced as gas inclusions with the suspension or which have collected in dead volumes. These gas quantities, for example air inclusions, can prevent a complete filling of the process zone.

The enclosed gas volume can be minimized, for example, if the planetary roller mixer is provided with degassing openings.

If more than one product inlet and/or more than one product outlet are provided for, all product outlets are preferably located above the product inlet during intended use.

The planetary roller mixer fills at least up to the height of the product outlet.

The product outlet is preferably located so far above the product inlet that the process zone can be filled with suspension to at least 80%, preferably to at least 90%, particularly preferably to at least 95%, without the product outlet having to be closed.

The product outlet at the top of the process zone is particularly preferred.

Before suspension can run out of the planetary roller mixer, it reaches the height of the product outlet, so that the process zone can be essentially completely filled.

Alternatively or additionally, the product outlet has a product discharge line that includes an overflow. For this purpose, the product discharge line can be arranged at least partially above a product inlet line provided at the product inlet. The overflow ensures that the suspension does not run off until a certain filling level has been reached; in this case, the process zone should be essentially completely filled during proper operation.

The product outlet pipe is preferably connected directly to an opening in the housing, the product inlet pipe is preferably arranged directly upstream of an opening in the housing.

The possibility of essentially filling the process zone completely without a backwater-forming device at the product outlet allows continuous processing of the suspension. This can be intensively homogenised and/or dispersed in the device in accordance with the invention and the solids can be further comminuted if necessary, whereby the processing takes place in a closed system without moving parts being accessible. This means that there is no danger to operating staff during operation. The closed device also reduces the risk of contamination by unintentional entry of gases or dirt from the environment and of impairment by incident light.

In an advantageous design of the planetary roller mixer, at least part of the planetary roller mixer can be tempered. In particular, the housing and/or the central spindle can be tempered.

The suspension can then be processed independently of the ambient temperature at a temperature that is favourable for the respective suspension components.

For temperature control, the planetary roller mixer has, in particular, temperature control channels through which a temperature control fluid, for example a cooling liquid, can be conducted. The temperature control channels can be formed in particular in the central spindle and/or in the housing, which each have a large surface which is in contact with the suspension.

The temperature control fluid can also be used to dissipate heat that may arise during processing of the suspension, for example due to friction.

The housing and the spindles can be arranged horizontally when used as intended.

The product outlet is preferably located above the product inlet so that the process zone can be filled with the suspension to be dispersed.

The central spindle is connected to a drive, in particular on the side of the product outlet, and preferably on the side of the product inlet it has no connection to the outlet space surrounding the housing.

In particular, the central spindle on the side of the product inlet is not extended out of the housing and is not connected to a shaft that extends out of the housing. The bearing of the central spindle must therefore not be sealed from the outside on the side of the product inlet, where typically high pressures prevail.

In an advantageous design of the planetary roller mixer, the housing and the spindles are arranged vertically when operating as intended.

A planetary roller mixer with a product outlet arranged above the product inlet during operation results in a simple manner in a vertically arranged planetary roller mixer, in which the housing and the spindles are vertically aligned during operation when the planetary roller mixer can be filled in the lower region and the suspension is discharged in the upper region. The suspension is thus conveyed from bottom to top and thus against gravity. The process zone is full at least up to the height of the product outlet.

In the planetary roller mixer, the suspension is moved between the surfaces of the gears. As a rule, the suspension is not pressed out of a nozzle, so that no large pressure has to be built up. A transport of the suspension towards the product outlet through the rotation of the spindles is therefore not necessary.

The gearing can include an angle with the longitudinal axis of the spindle, for example 45°. The spindles then drive the suspension.

Advantageously, the spindles, the housing and/or the bushing have at least one region in which the toothing is designed in such a way that during operation through the toothing no advance of the suspension in a direction from the product inlet to the product outlet can be effected. For example, this area may have a straight toothing in which the toothing is aligned parallel to the spindle axis.

In particular, the gearing along the entire central spindle is designed in such a way that no drive through the spindles is possible.

Alternatively or additionally, the spindles, the housing and/or the bushing have at least one area in which the gearing is designed in such a way that during operation the gearing can be used to effect backward conveying in the direction of the product inlet. The suspension must then be pumped through the planetary roller mixer by feeding the suspension, for example by means of a separate pump.

The suspension remains in the process zone for a relatively long time without active propulsion through the spindles and undergoes intensive machining.

The planetary roller mixer prefers a driving device for driving the central spindle which, for example, provides a power range of up to 90 kW. The drive equipment includes, for example, a drive motor, a belt drive, an additional gearbox if necessary and/or a bearing arrangement.

The planetary roller mixer is preferably operated at a speed of 300 to 3000 revolutions per minute, preferably at 300 to 2000 revolutions per minute.

The central spindle is typically extended out of the housing on one side and can be connected to the drive unit there.

Since the suspension is present in liquid form both at the inlet and at the outlet, it is of secondary importance, especially in a horizontal arrangement, whether the central spindle is led out of the housing on the side of the product outlet or on the side of the product inlet. In any case, a seal is necessary.

The drive unit is preferably located closer to the product outlet than to the product inlet. The product flow between the product inlet and outlet is therefore preferably in the direction of the drive unit.

Since the suspension is typically driven by a conveyor upstream of the planetary roller mixer, the pressure is greatest in the planetary roller mixer near the product inlet. The central spindle is therefore preferably guided out of the housing on the product outlet side and coupled to the drive unit and sealed on the product outlet side, where a lower pressure is applied.

In an advantageous design of the planetary roller mixer, a seal is provided between the central spindle and the driving device.

The seal provides fluid tightness, and can be designed to withstand pressures up to about 10 bar.

A mechanical seal, a stuffing box or a threaded spiral can be used as a seal.

The planetary roller mixer is advantageously dimensioned in such a way that the process zone of the planetary roller mixer comprises an empty volume of less than 20 1, in particular of 1-10 1. The process zone of the planetary roller mixer is designed in such a way that the empty volume of the planetary roller mixer is less than 20 1, in particular of 1-10 1. The planetary roller mixer is designed in such a way that the empty volume of the planetary roller mixer is less than 20 1.

The empty volume of the process zone is usually the internal volume of the housing or bushing minus the volume of the central spindle and the planetary spindles. Due to the spindles, the empty volume of the process zone is considerably smaller than the inner volume of the housing or bushing.

Since the planetary roller mixer can be used in continuous operation, the rather small empty volume is sufficient for processing.

The housing, the bushing and/or the spindles are usually made of steel.

In an advantageous version of the planetary roller mixer, at least one element of the planetary roller mixer being in contact with the suspension during intended use, has a coating containing or consisting of a ceramic material on the surface which is in contact with the suspension during operation.

Alternatively, the element is made of ceramic material.

Elements in contact with the suspension include the central spindle, the planetary spindles, the housing and/or bushing.

These can be made of ceramic, have a ceramic toothing on a core, for example made of steel, or have a ceramic coating.

Silicon carbide or silicon nitride can be used as the ceramic material.

Ceramic materials often exhibit high mechanical and chemical stability. They therefore have a service life that enables a large number of operating hours without the need to replace the corresponding elements in contact with the suspension.

The planet spindles are usually arranged parallel to the central spindle and can extend over the entire length of the central spindle.

In a conceivable version of the planetary roller mixer, the planetary roller mixer comprises at least one planetary spindle consisting of segments arranged on a common axis. Alternatively or additionally, the planetary roller mixer comprises segments with toothing which are operatively connected to both the toothing of the central spindle and the internal toothing of the housing or bushing, the segments being arranged one behind the other in the longitudinal direction and offset relative to one another in the circumferential direction.

In order to avoid a collision of the planetary spindle segments, a guide ring can be provided to hold the segments in position, especially in the longitudinal direction.

The longitudinal direction is the axial direction of the central spindle.

Short spindles are often easier to produce and therefore cheaper per length. If adjacent planetary spindles in the longitudinal direction are also offset in the circumferential direction, the suspension within the planetary roller mixer is guided over longer distances and undergoes more intensive machining.

The product deflection can be reinforced by the built-in guide rings for positioning the planet spindle segments offset in the circumferential direction.

The task underlying the invention is solved by a production plant for processing a suspension with a conveying device, namely a pressing device, and a planetary roller mixer, in particular as described above.

The pressing device comprises a stamping element and a storage container.

The emptying of the storage container of the pressing device, which should be as free of residues as possible, is carried out by means of the stamping element, preferably connected to a piston, which can be driven pneumatically, hydraulically or with a motor, depending on the required squeezing pressure.

The task on which the invention is based is alternatively solved by a production plant for processing a suspension with a conveying device, for example a screw conveyor or a pressing device, and a planetary roller mixer, in particular as described above, as well as a dosing device which is connected downstream of the conveying device.

The dosing device can be a pump or a valve. The valve can be directly connected to the conveying device, for example at the outlet of a screw conveyor or at the outlet of a press. The dosing device is preferably controllable, for example as a clocked valve, so that certain flow rates can be dosed.

The invention-based production plant has the advantage that it is also possible to feed highly viscous starting materials into the planetary roller mixer in precise doses. This also enables a continuous process for such starting materials.

The planetary roller mixer comprises a housing which is substantially cylindrical on the inside and is provided with an internal toothing, or has at least one substantially cylindrical bushing with internal toothing. The planetary roller mixer comprises at least one product inlet in a first end portion of the housing and at least one product outlet in a second end portion of the housing. The planetary roller mixer also comprises at least one central spindle with toothing arranged in the housing and at least one planetary spindle with toothing arranged in the housing, whereby the toothing of the planetary spindle is operatively connected both with the toothing of the central spindle and the internal toothing of the housing or the bushing.

The product outlet is located above or at the same level as the product inlet during intended use.

The conveying device is located outside the housing upstream of the product inlet and is in fluid connection with the product inlet. The conveying device can be fed from a premixer or a feed hopper.

The conveying device may be a pressing device.

The pressing device is typically used to squeeze highly viscous suspension through an outlet that can be closed with a valve using the punch element. The suspension can be conveyed into and through the planetary roller mixer by the stamping element.

However, such extrusion devices usually do not have a high dosing accuracy, so they can be coupled with a downstream dosing device, for example a pump, which ensures a desired, for example constant, product flow in and through the planetary roller mixer.

Low-viscosity suspensions can also be sucked out of a feed tank solely by means of a pump.

In particular, the production plant includes a pump.

The pump is preferably designed separately from the planetary roller mixer and is not integrated into the housing of the planetary roller mixer.

Preferably, the conveying device with the planetary roller mixer and/or the dosing device with the planetary roller mixer are in fluid contact via a line, for example a product inlet line.

Preferably, the entire suspension can be fed from the conveyor system into the planetary roller mixer. The planetary roller mixer preferably has only one product inlet, which is in fluid connection with the conveying device, e.g. the pump or the squeezing device. In particular, the planetary roller mixer does not have a separate solids inlet.

In a preferred design of the production plant, the production plant has at least one premixer. Preferably the premixer is arranged upstream of the planetary roller mixer. The components of the suspension, i.e. liquid and solid particles, can be premixed in the premixer so that a suspension can be fed into the planetary roller mixer.

The production plant can be used for a single pass of suspension. The processed suspension can be collected and passed through the production plant again, i.e. the production plant can be used in multi-pass operation.

The task on which the invention is based is solved by a production plant, in particular as described above, comprising a planetary roller mixer. The planetary roller mixer comprises a housing which is substantially cylindrical on the inside and is provided with an internal toothing, or has at least one substantially cylindrical bushing with internal toothing. The planetary roller mixer comprises at least one product inlet in a first end portion of the housing and at least one product outlet in a second end portion of the housing. The planetary roller mixer comprises a central spindle with toothing arranged in the housing and at least one planetary spindle with toothing arranged in the housing, whereby the toothing of the planetary spindle is operatively connected both with the toothing of the central spindle and the internal toothing of the housing or the bushing. The product outlet is located above or at the same level as the product inlet during intended use. The production plant is equipped with a conveying device which is located outside the housing upstream of the product inlet and is in fluid connection with the product inlet. The production plant has a product line through which suspension can be fed from the planetary roller mixer into the conveying device, from where the suspension can be fed back into the planetary roller mixer.

The production plant can have a product line via which suspension can be fed from the planetary roller mixer into a premixer and a further product line via which the suspension can be fed from the premixer into the conveying device from where the suspension can be fed back into the planetary roller mixer.

The production plant can thus be operated in a closed loop process, whereby the suspension can remain in the production plant until a desired quality is achieved. The production plant can be equipped with a sensor that records a measurement value that allows conclusions to be drawn about the quality of the suspension, for example a viscosity and/or particle size sensor.

The task underlying the invention is also solved by a method for dispersing suspensions comprising at least the following step:

A suspension is dispersed in a planetary roller mixer, in particular as described above, whereby essentially the entire process zone of the planetary roller mixer is filled with suspension.

The planetary roller mixer comprises a housing which is essentially cylindrical on the inside and is provided with an internal toothing. Alternatively or additionally, the planetary roller mixer has at least one essentially cylindrical bushing with internal toothing. The planetary roller mixer comprises at least one product inlet in a first end portion of the housing and at least one product outlet in a second end portion of the housing. The planetary roller mixer also comprises at least one central spindle with toothing arranged in the housing and at least one planetary spindle with toothing arranged in the housing, whereby the toothing of the planetary spindle is operatively connected with the toothing of the central spindle as well as the internal toothing of the housing or the bushing. The product outlet is preferably located above or at the same level as the product inlet during intended use.

The dispersion takes place in the process zone between a central spindle with toothing, at least one rotating planet spindle with toothing and a housing with internal toothing or at least one bushing with internal toothing.

The suspension is conveyed through the process zone of the planetary roller mixer by means of a conveying device, namely a pressing device with a stamping element (29) and a storage container, which is arranged outside the housing of the planetary roller mixer upstream of the product inlet.

Alternatively, the suspension is conveyed through the process zone of the planetary roller mixer by means of a conveying device, which is arranged outside the housing of the planetary roller mixer upstream of the product inlet, and a dosing device, in particular a dosing valve or a pump, which is connected downstream of the conveying device.

The pressure in the planetary roller mixer is greater near the product inlet than on the product outlet side, in particular the greatest pressure is applied in the planetary roller mixer at the product inlet.

Dispersing takes place preferably at a product inlet pressure between 0.2 and 10 bar.

When exiting the planetary roller mixer, the temperature of the suspension preferably is between 5° C. and 150° C.

For example, pre-mixed UV offset paste is processed in the planetary roller mixer, whereby organic pigment and fillers are dispersed to particle sizes below 10 micrometers in the printing ink. A product temperature of 60° C. is not exceeded.

Conventional offset printing ink can also be processed in the planetary roller mixer, in which, for example, pearled carbon black is incorporated into a binder and comminuted to particle sizes of less than 15 micrometers. A maximum permissible product temperature of 120° C. is not exceeded.

Lubricating grease can be processed in the planetary roller mixer in which a thickener and/or additives are homogenized to particle sizes of 10 to 15 micrometers.

In an advantageous version of the method, suspensions with a viscosity of 0.1 to 50 Pa·s, in particular 0.7 to 6 Pa·s, are added to the planetary roller mixer.

The viscosity can be determined with a rheometer at temperatures of 25 to 90° C., in particular 50-70° C., and a shear rate of 450 1/s.

A filling paste to be processed with a viscosity of 4 Pa·s at 50° C. and 450 1/s can be fed to a pump by a pressing device, and from there to the planetary roller mixer.

A highly viscous paste with a viscosity of 50 Pa·s at 25° C. and 450 1/s can be fed to the planetary roller mixer via a pressing device without an intermediate pump.

Preferably, a suspension having been premixed in a premixer is processed in the planetary roller mixer, whereby the suspension is premixed outside the planetary roller mixer in a premixer arranged upstream of the planetary roller mixer and fed to the planetary roller mixer via a product inlet line by means of a conveying device.

The suspension is thus further dispersed in the planetary roller mixer, but already reaches the planetary roller mixer as a premixed suspension. The planetary roller mixer can therefore be fed from only one product inlet line. The planetary roller mixer does not have to have a solids inlet.

Advantageously, the suspension is pumped into the planetary roller mixer and/or the suspension is conveyed through the planetary roller mixer by means of a conveying device, in particular a pump and/or pressing device.

Preferably, the product flow in a vertically arranged planetary roller mixer runs from bottom to top.

The product flow between the product inlet and outlet is preferably in the direction of the drive unit.

The suspension can pass through the planetary roller mixer at least twice, for example in multi-pass operation or in closed-loop operation.

Preferred examples of the invention are explained in more detail in the following description by means of the attached drawings. Corresponding elements are provided the same reference signs.

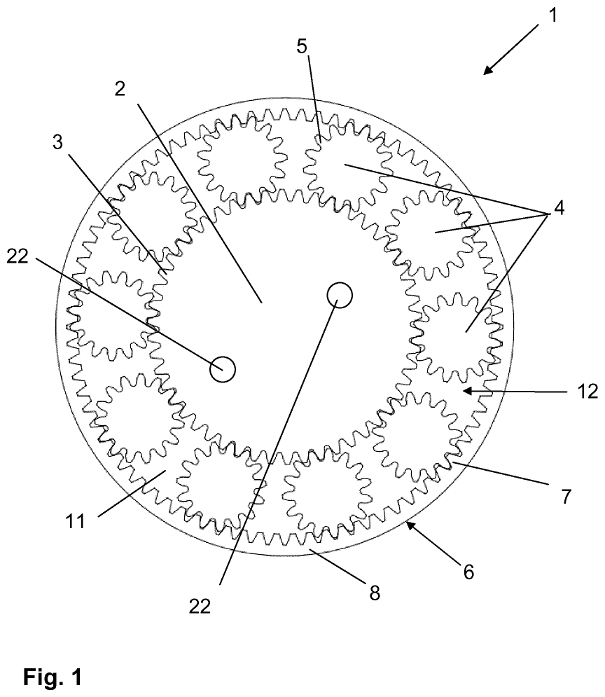

FIG. 1 shows a schematic representation of a planetary roller mixer in sectional view;

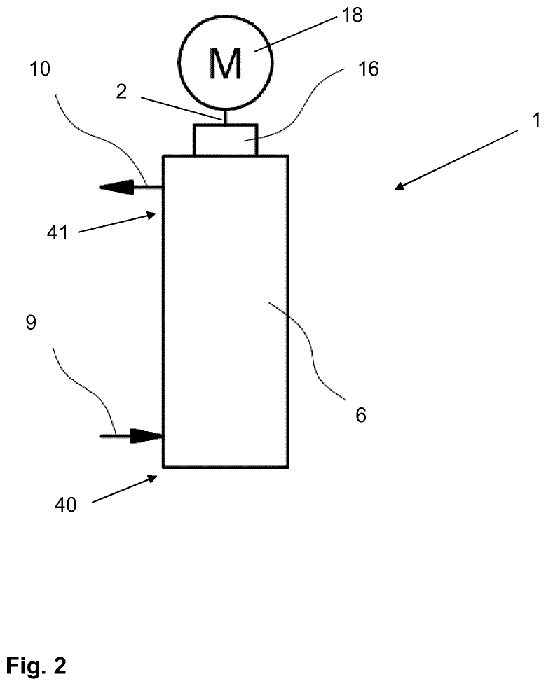

FIG. 2 shows a schematic representation of a first example of a planetary roller mixer in side view;

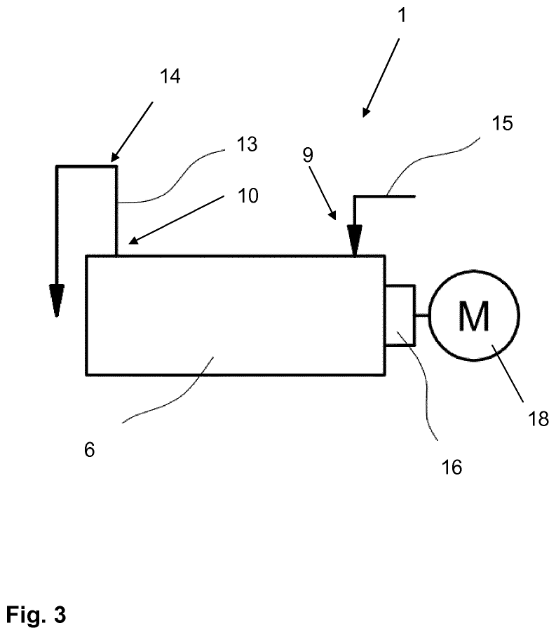

FIG. 3 shows a schematic representation of a second example of a planetary roller mixer in lateral view;

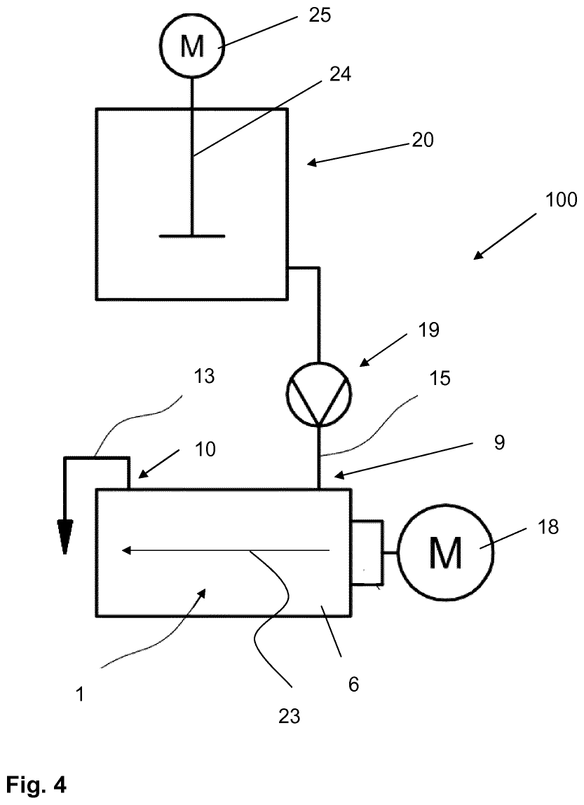

FIG. 4 shows a schematic flow chart of a first example for a production line;

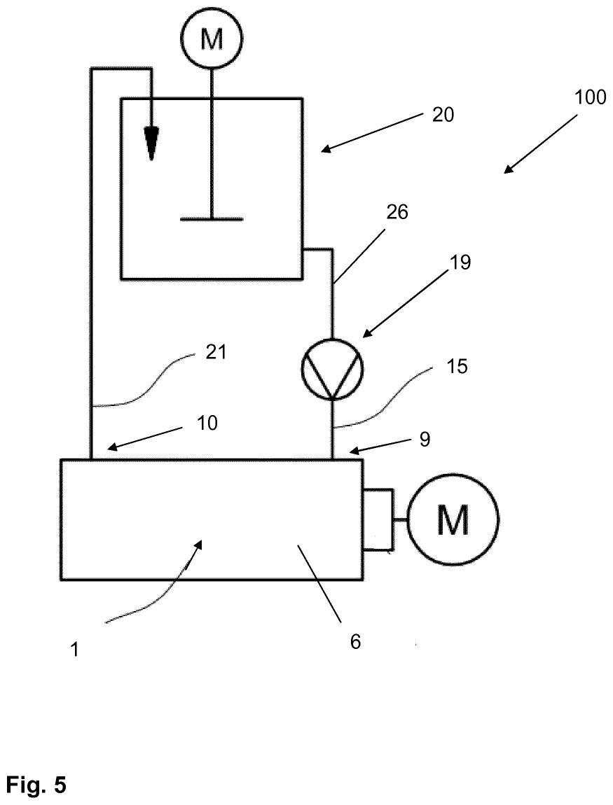

FIG. 5 shows a schematic flow chart of a second example for a production plant;

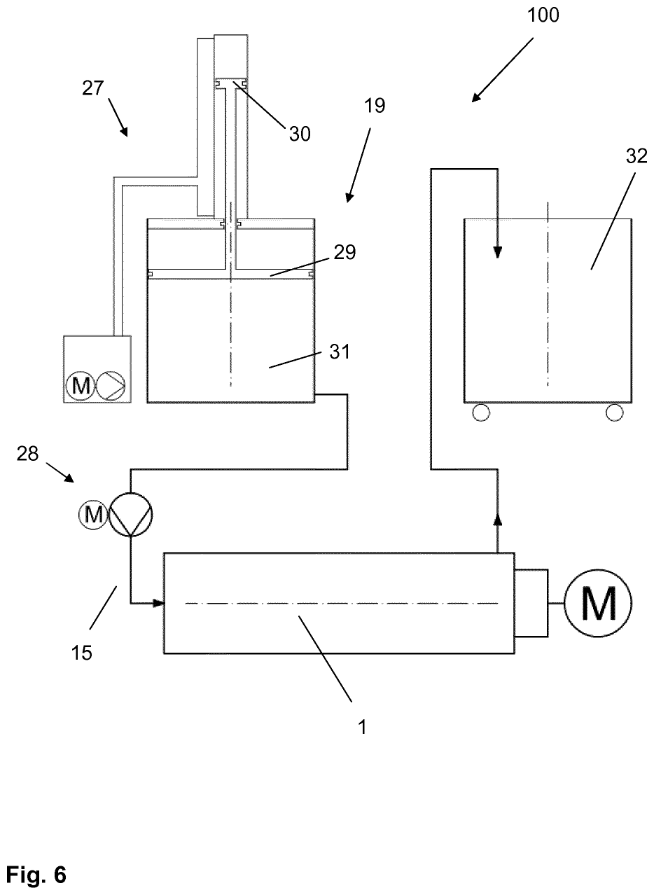

FIG. 6 shows a schematic flow chart of a third example for a production plant;

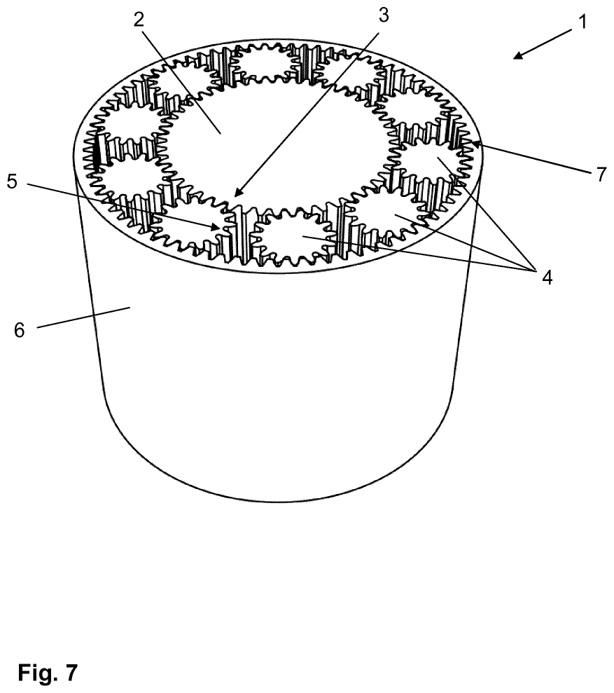

FIG. 7 shows a schematic representation of the third example of a planetary roller mixer in perspective view;

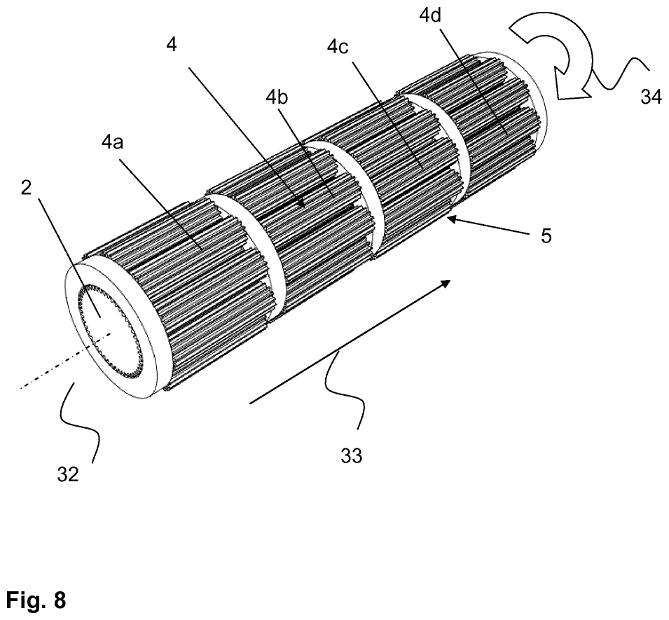

FIG. 8 shows a schematic representation of a part of the third example for a planetary roller mixer in another perspective view;

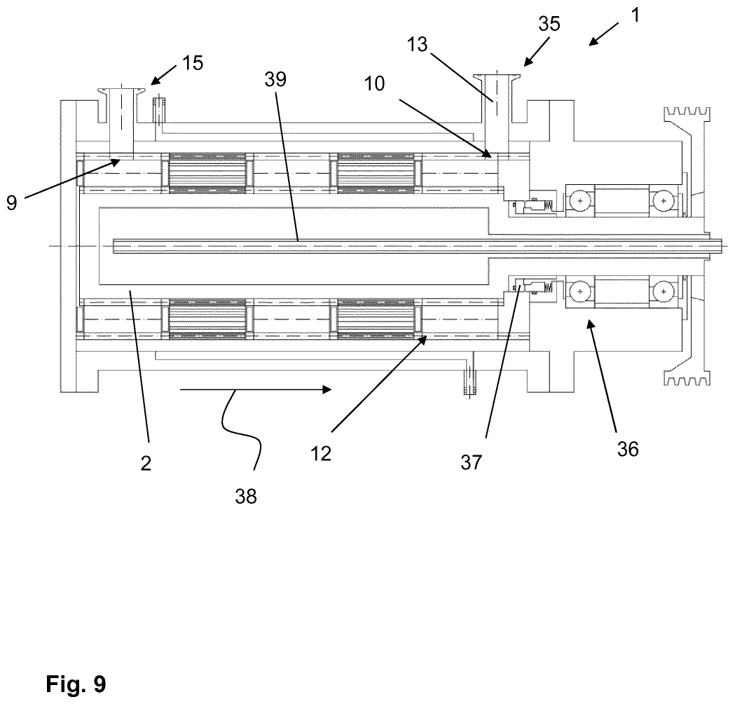

FIG. 9 shows the third example of a planetary roller mixer in sectional view.

FIG. 1 shows a schematic representation of a planetary roller mixer 1 in sectional view.

The planetary roller mixer 1 comprises a central spindle 2 with toothing 3, a plurality of rotating planetary spindles 4, each with toothing 5, and a housing 6 with a bushing 8 with internal toothing 7.

The toothing 5 of the planet spindles 4 is on the one hand in active connection with the toothing 3 of the central spindle 2, on the other hand with the internal toothing 7.

Temperature control channels 22 are provided in the central spindle.

The process zone 12 is located between spindles 2, 4 and bushing 8 and has an empty volume 11 of about 1-10 1.

FIG. 2 shows a schematic representation of a first example for a planetary roller mixer 1 in lateral view. The housing 6 and the spindles 2, 4, not explicitly shown, are vertically aligned in the operating position.

The planetary roller mixer 1 comprises a product inlet 9 in a first end area 40 of the housing 6 and a product outlet 10 in a second end area 41 of the housing 6, the product outlet 10 being arranged above the product inlet 9.

Process zone 12 of dispersion device 1 can be filled essentially completely during operation.

The central spindle 2 is extended out of the housing 6 in the upper area of the dispersing device 1 and can be driven by a driving device 18, in this case a motor.

Between the central spindle 2 and a bearing housing 16 or a gear, not explicitly shown, a seal, not explicitly shown, is provided, in particular a mechanical seal.

FIG. 3 shows a schematic representation of a second example for a planetary roller mixer 1 in lateral view. The housing 6 and the spindles 2, 4, not explicitly shown, are aligned horizontally in the operating position.

The planetary roller mixer 1 comprises a product inlet 9 and a product outlet 10, the product outlet 10 having an intended product discharge line 13 comprising an overflow 14. The product discharge line 13 is arranged at least partially above a product inlet line 15 provided at the product inlet 9, so that the process zone 12 of the planetary roller mixer 1, which is not explicitly shown, can essentially be completely filled with suspension.

The driving unit 18 for the central spindle 2 provides a power range up to 90 kW.

FIG. 4 shows a schematic flow diagram of a first example of a production line 100 for processing a suspension.

The production plant 100 comprises a conveying device, here a pump 19, for example a screw conveyor, which is provided with a dosing valve being arranged downstream, and a planetary roller mixer 1, in the example shown in horizontal arrangement, with a central spindle with toothing, not explicitly shown, a revolving planet spindle with toothing 5, not explicitly shown, and a housing 6 with internal toothing 7, not explicitly shown (see FIG. 1).

The planetary roller mixer 1 comprises a product inlet 9 which is equipped with a product inlet line 15 and a product outlet 10 with a product discharge line 13. The entire suspension can be guided via the product inlet line 15 from the pump 19 into the planetary roller mixer 1.

The production line 100 also includes a premixer 20, which has at least one stirring tool 24 driven by at least one motor 25.

The pump 19 pumps premixed suspension from the premixer 20 in the planetary roller mixer 1.

The pump 19 also ensures that the suspension is conveyed through the planetary roller mixer 1 in a direction 23 from the product inlet 9 to the product outlet 10. Although the motor 18 causes the spindles to rotate, it does not drive the suspension in the dispersing device 1.

FIG. 5 shows a schematic flow diagram of a second example of a production line 100 for processing a suspension.

Similar to the example in FIG. 4, the production plant 100 comprises a pump 19 as conveying device 19, for example a screw conveyor provided with a downstream dosing valve, as well as a planetary roller mixer 1, in the example shown in horizontal arrangement, with a central spindle with toothing, not explicitly shown, a circumferential planet spindle 4 with toothing 5, not explicitly shown, and a housing 6 with internal toothing 7, not explicitly shown (see FIG. 1).

The planetary roller mixer 1 comprises a product inlet 9, which is equipped with a product inlet line 15, and a product outlet 10. The entire suspension can be fed from the pump 19 into the planetary roller mixer 1 via the product inlet line 15.

The production line 100 also includes a premixer 20.

The product outlet 10 is connected to a product line 21 via which a suspension can be fed from the planetary roller mixer 1 into the pre-mixer 20.

In the premixer 20, the more homogenised and/or dispersed suspension is mixed with the less homogenised and/or dispersed suspension.

Via a further product line 26, the suspension is fed from the premixer 20 into the pump 19, from where the suspension is fed through a product inlet line 15 into the planetary roller mixer 1.

The production plant 100 can be operated in a closed loop process until the suspension has the desired quality.

FIG. 6 shows a schematic flow diagram of a third example of a production line 100 for processing a suspension.

As in the previous examples, the production line 100 comprises a planetary roller mixer 1, in the example shown it is arranged horizontally.

The conveying device 19 can be a pressing device 27 and the dosing device can be a pump 28 connected in series. Highly viscous suspension is pressed out of a storage tank 31 by means of a stamping element 29, which is operated by a piston 30. The pump ensures that the suspension is fed evenly to the planetary roller mixer 1 via the product inlet pipe 15.

The processed suspension is collected in a collection tank 32. Alternatively, the suspension can be returned to the conveyor 19.

FIG. 7 shows a schematic view of a third planetary roller mixer 1 in perspective. The central spindle 2, the planetary spindle 4, the housing 6 have a straight toothing 3, 5, 7. During operation, the toothing 3, 5, 7 prevents the suspension from being propelled.

FIG. 8 shows a schematic representation of part of the third example of a planetary roller mixer in perspective.

The planetary roller mixer 1 comprises as planetary spindles 4 segments 4a, 4b, 4c, 4d, which are arranged one behind the other in the longitudinal direction 33 and offset against each other in the circumferential direction 34.

The planet spindles 4 have a straight toothing 5. The toothing 5 runs parallel to the longitudinal axis 32 of the central spindle 2 and therefore does not cause any propulsion.

FIG. 9 shows the third example for the planetary roller mixer 1 in sectional view.

The product discharge line 13 is designed as overflow 35. For this purpose, the product discharge line 13 is arranged at least partially above the product inlet line 15 provided at product inlet 9.

The process zone 12 is sealed with a mechanical seal 37 against the bearing 36 of the central spindle 2. The central spindle 2 can be tempered by means of a temperature control lance 39.

The product flow between product inlet 9 and product outlet 10 takes place in direction 38 of the drive unit, not explicitly shown.

1. A production plant for processing a suspension with a planetary roller mixer comprising:
a housing,
which is substantially cylindrical on an inside and provided with an internal toothing, or
comprising at least one substantially cylindrical bushing with an internal toothing;
at least one product inlet in a first end portion of the housing; and
at least one product outlet in a second end region of the housing;
a central spindle with toothing arranged in the housing;
at least one planetary spindle with toothing arranged in the housing;
wherein the toothing of the planetary spindle is operatively connected both to the toothing of the central spindle and to the internal toothing of the housing or the bushing;
the product outlet is arranged above or at the level of the product inlet when operated as intended; and
the production plant comprises a conveying device which is arranged outside the housing upstream of the product inlet and is in fluid connection with the product inlet, and the production plant comprises a dosing device, m particular a pump or a dosing valve, which is connected downstream of the conveying device.

2. A production plant for processing a suspension with a planetary roller mixer comprising:
a housing,
which is substantially cylindrical on an inside and provided with an internal toothing, or
comprising at least one substantially cylindrical bushing with an internal toothing;
at least one product inlet in a first end portion the housing; and
at least one product outlet in a second end region of the housing;
a central spindle with toothing arranged in the housing;
at least one planetary spindle with toothing arranged in the housing;
wherein the toothing of the planetary spindle is operatively connected both to the toothing of the central spindle and to the internal toothing of the housing or the bushing;
the product outlet is arranged above or at the level of the product inlet when operated as intended; and
the production plant comprises a conveying device, namely a pressing device with a stamping element and a storage container, which is arranged outside the housing upstream of the product inlet and is in fluid connection with the product inlet.

3. The production plant according to claim 1, wherein the conveying device is a pressing device with a stamping element and a storage container.

4. The production plant according to claim 4, wherein the pressing device has an outlet which is closeable by a valve.

5. The production plant in accordance with claim 1, wherein the housing and the spindles of the planetary roller mixer are arranged horizontally during intended use and the product outlet is arranged above the product inlet.

6. The production plant in accordance with claim 1,
wherein the housing and the spindles of the planetary roller mixer are arranged horizontally during intended use, and
the central spindle is connected on the side of the product outlet to a driving device, and
preferably the central spindle on the side of the product inlet has no connection to the outer space surrounding the housing.

7. The production plant in accordance with claim 1, wherein a mechanical seal is provided between the central spindle and a bearing housing or a gear mechanism.

8. The production plant in accordance with claim 1, wherein the production plant comprises a premixer.

9. A production plant for processing a suspension with a planetary roller mixer,
with a planetary roller mixer comprising:
a housing,
which is substantially cylindrical on an inside and provided with an internal toothing, or
comprising at least one substantially cylindrical bushing with an internal toothing;
at least one product inlet in a first end portion of the housing; and
at least one product outlet in a second end region of the housing;
a central spindle with toothing arranged in the housing;
at least one planetary spindle with toothing arranged in the housing;
wherein the toothing of the planetary spindle is operatively connected both to the toothing of the central spindle and to the internal toothing of the housing or the bushing; wherein the product outlet is arranged above or at the level of the product inlet during intended operation: and
wherein the production plant comprises a conveying device which is arranged outside the housing upstream of the product inlet and is in fluid connection with the product inlet,
wherein the production plant comprises a product line via which suspension can be guided from the product outlet out of the planetary roller mixer into the conveying device, from where the suspension can be guided again into the planetary roller mixer, and the suspension preferably is guided from the planetary roller mixer into a premixer and is guided via a further product line from the premixer into the conveying device.

10. The production plant in accordance with claim 1, wherein the planetary roller mixer comprises a driving device for driving the central spindle, which driving device is arranged closer to the product outlet than to the product inlet.

11. The production plant in accordance with claim 1, wherein the central spindle, the planetary spindle, the housing and/or the bushing have at least one region in which the toothing is designed in such a way that, during operation, the toothing cannot drive the suspension, and this region in particular has a straight toothing.

12. The production plant according claim 1, wherein the planetary roller mixer comprises at least one planetary spindle consisting of segments arranged on a common axis; and/or segments with toothing which are connected both to the toothing of the central spindle and to the internal toothing of the housing or housing, respectively, and to the internal toothing of the housing, or of the bushing, and the segments are offset relative to one another in a circumferential direction and are arranged one behind the other in longitudinal direction.

13. A method for dispersing suspensions comprising at least the following step.
Dispersing a suspension in a production plant with a planetary roller mixer and a conveying device and a metering device, comprising:
a housing
which is substantially cylindrical on an inside and provided with an internal toothing, or
comprising at least one substantially cylindrical bushing with an internal toothing;
at least one product inlet in a first end portion of the housing; and
at least one product outlet in a second end region the housing;
a central spindle with toothing arranged in the housing;
at least one planet spindle with toothing arranged in the housing;
wherein the toothing of the planetary spindle is operatively connected both to the toothing of the central spindle and to the internal toothing of the housing or the bushing;
the product outlet is arranged above or at the level of the product inlet during intended use;
with a process, essentially the entire process zone of the planetary roller mixer is filled with suspension, the suspension is conveyed through the process zone of the planetary roller mixer by a conveying device, which is arranged upstream of the product inlet outside the housing of the planetary roller mixer, and a dosing device; which is connected downstream of the conveying device.

14. A method for dispersing suspensions comprising at least the following step:
Dispersing a suspension in a production plant with a planetary roller mixer
and a conveying device and a dosing device, comprising:
a housing
which is substantially cylindrical on an inside and provided with an internal toothing, or
comprising at least one substantially cylindrical bushing with an internal toothing;
at least one product inlet in a first end portion of the housing; and
at least one product outlet in a second end region of the housing;
a central spindle with toothing arranged in the housing;
at least one planet spindle with toothing arranged in the housing;
wherein the toothing of the planetary spindle is operatively connected both to the toothing of the central spindle and to the internal toothing of the housing or the bushing;
the product outlet is arranged above or at the level of the product inlet during intended use;
with a process zone, substantially the entire process zone of the planetary roller mixer is filled with suspension, the suspension is conveyed through the process zone of the planetary roller mixer by a conveying device, namely a pressing device with a stamping element and a storage container, which is arranged outside the housing of the planetary roller mixer upstream of the product inlet.

15. The method according to claim 14, wherein the pressure in the planetary roller mixer, in a vicinity of the product inlet, is greater than on the product outlet side, and the suspension is dispersed at a product inlet pressure between 0.2 and 10 bar.

16. The method according to claim 14, wherein the planetary roller mixer has a driving device on one side of the central spindle for driving the central spindle, and the product flow between product inlet and product outlet takes place in the direction of the driving device.

17. The method according to claim 14, wherein suspension, premixed in a premixer is processed in the planetary roller mixer.

18. The method according to claim 14, wherein the suspension is pumped into the planetary roller mixer and/or the suspension is conveyed through a process zone of the planetary roller mixer a pump which is arranged outside the housing of the planetary roller mixer upstream of the product inlet.

19. The method according to claim 14, wherein the product flow in a vertically arranged planetary roller mixer extends from bottom to top.

20. A method for dispersing suspensions, comprising at least the following step:
Dispersing a suspension in a production plant with a planetary roller mixer comprising;
a housing
which is substantially cylindrical on an inside and provided with an internal toothing, or
comprising at least one substantially cylindrical bushing with an internal toothing;
at least one product inlet in a first end portion of the housing; and
at least one product outlet in a second end region of the housing;
a central spindle with a toothing arranged in the housing;
at least one planet spindle with a toothing arranged in the housing;
wherein the toothing of the planetary spindle is operatively connected both to the toothing of the central spindle and to the internal toothing of the housing or the bushing;
the product outlet is arranged above or at the level of the product inlet when operated as intended; with a process zone, essentially the entire process zone of the dispersing device being filled with suspension, and the suspension passes through the planetary roller mixer at least twice.
